(19) United States
(12) Patent Application Publication
(10) Pub. No.: US 2012/0328929 A1
(43) Pub. Date: Dec. 27, 2012

(54) SEPARATOR FOR ELECTROCHEMICAL DEVICE, ELECTROCHEMICAL DEVICE USING SAME, AND METHOD FOR PRODUCING THE SEPARATOR FOR ELECTROCHEMICAL DEVICE

(76) Inventors: Nobuaki Matsumoto, Osaka (JP); Hideaki Katayama, Kyoto (JP)

(21) Appl. No.: 13/582,306

(22) PCT Filed: Mar. 14, 2011
(86) PCT No.: PCT/JP2011/055904

§ 371 Date: Aug. 31, 2012

(30) Foreign Application Priority Data
Apr. 16, 2010 (JP) 2010-094565

(51) Int. Cl. H01M 2/16; B05D 5/12

(52) U.S. Cl. 429/144; 427/79; 427/58

(57) ABSTRACT

A separator for an electrochemical device of the present invention includes, on at least one side of a resin porous film including a thermoplastic resin as a main component, a heat-resistant porous layer including heat-resistant fine particles as a main component. The resin porous film has a surface tension (wetting index) A of 35 mN/m or less, the heat-resistant porous layer is made from a heat-resistant porous layer forming composition containing a water-based solvent and having a surface tension B of less than 29 mN/m, and a relationship between the surface tension (wetting index) A and the surface tension B satisfies A>B.

### TECHNICAL FIELD

The present invention relates to a separator for an electrochemical device, which includes a highly heat-resistant layer and has good productivity, an electrochemical device using the separator, and a method for producing the separator.

### BACKGROUND ART

Resin porous films predominantly composed of thermoplastic resins have been used broadly in electrochemical devices such as lithium-ion batteries, polymer lithium batteries and electric double layer capacitors as separators for separating the positive and negative electrodes. Separators predominantly composed of polyolefin, in particular, have been used widely because they are stable in extreme redox atmospheres in lithium-ion batteries and the like and they can ensure a so-called shutdown property by closing their pores at about the melting point of polyolefin, the constituent resin.

On the other hand, separators including a resin porous film predominantly composed of a thermoplastic resin can get ripped easily at temperatures higher than the melting point of the thermoplastic resin because they lack the ability to maintain the film. The occurrence of such ripping in an electrochemical device may lead to the phenomenon of short circuit in which the positive and negative electrodes come into direct contact.

In order to improve the heat-resistance stability of separators including such a resin porous film, techniques of forming, on the surface of the resin porous film, a layer containing a highly heat-resistant material such as inorganic oxide have been studied (e.g., Patent Documents 1 to 3).

In each of the laminated separators described in Patent Documents 1 to 3, the adherence between the resin porous film as the substrate and the layer containing a highly heat-resistant material such as inorganic oxide may present a problem. In some instances, the highly heat-resistant material-containing layer is formed through the steps of dispersing the highly heat-resistant material in a solvent, such as water, to prepare a composition (paint), and coating the surface of the resin porous film with the composition. In this case, a low affinity between the resin porous film and the composition for forming the highly heat-resistant material-containing layer may prevent the favorable application of the composition, and this may result in the deterioration of the properties of the highly heat-resistant material-containing layer. For these reasons, in the techniques described in Patent Documents 2 and 3, the surface tension (wetting index) of the resin porous film is adjusted to 40 mN/m or more to allow the favorable formation of the highly heat-resistant material containing layer and to improve the adherence between the highly heat-resistant material-containing layer and the resin porous film.

### PRIOR ART DOCUMENTS

### Patent Documents

Patent Document 1: JP 2008-123996 A

Patent Document 2: JP 2008-186722 A

Patent Document 3: JP 2010-21033 A

### DISCLOSURE OF INVENTION

### Problem to be Solved by the Invention

Polyolefin porous films, for example, have a surface tension (wetting index) of less than 40 mN/m. Thus, in the techniques described in Patent Documents 2 and 3, the surface of a polyolefin porous film is subjected to a hydrophilic treatment such as a corona discharge treatment, plasma treatment or the like, to adjust the surface tension (wetting index) to 40 mN/m or more. However, in some cases, subjecting the polyolefin porous film to the hydrophilic treatment may cause heat damage to the polyolefin porous film, such as the resin being melted locally. Further, the polyolefin porous film may bear electrical charges as a result of undergoing the hydrophilic treatment, and heat produced by the release of the borne electrical charges may also cause heat damage, such as melting, to the polyolefin porous film. The heat damage to the polyolefin porous film may become a cause of a failure of the laminated separator. Further, dogging may occur due to the polyolefin constituting the porous film being melted, and this may become a cause of the deterioration of the load characteristics or the charge/discharge cycle characteristics.

For these reasons, there are demands for the development of techniques by which laminated separators can be produced productively without subjecting resin porous films as the substrate to a hydrophilic treatment.

As a means to form a highly heat-resistant material-containing layer favorably without subjecting a resin porous film to the hydrophilic treatment, an organic solvent, such as methylethyl ketone, tetrahydrofuran, alcohol, etc., may be used as the solvent of the composition for forming the highly heat-resistant material-containing layer. In this case, the wettability of the composition with respect to the resin porous film can be improved without subjecting a resin porous film having a small surface tension (wetting index) such as a polyolefin porous film to the hydrophilic treatment, so that the surface of the resin porous film can be coated favorably with the composition. In this case, however, the composition may pass through the resin porous film all the way to the opposite side of the coating surface (the occurrence of so-called “strike through”). Consequently, the composition or its solvent may adhere to rollers utilized as guides in a coater used for applying the composition, so that the favorable application of the composition onto the surface of the resin porous film may be prevented.

With the foregoing in mind, the present invention provides a separator for an electrochemical device, which includes a highly heat-resistant layer and has good productivity, an electrochemical device using the separator, and a method for producing the separator.

### Means for Solving Problem

The separator for an electrochemical device of the present invention is a separator including, on at least one side of a resin porous film including a thermoplastic resin as a main component, a heat-resistant porous layer including heat-resistant fine particles as a main component. The resin porous film has a surface tension (wetting index) A of 35 mN/m or less, the heat-resistant porous layer is made from a heat-resistant porous layer forming composition containing a water-based solvent and having a surface tension B of less than 29 mN/m, and the relationship between the surface tension (wetting index) A and the surface tension B satisfies A>B.

The electrochemical device of the present invention is an electrochemical device including a positive electrode, a negative electrode, a separator, and a nonaqueous electrolyte. The separator is the separator for an electrochemical device of the present invention.

Further, the method for producing a separator for an electrochemical device of the present invention is a method for producing a separator including, on at least one side of a resin porous film including a thermoplastic resin as a main component, a heat-resistant porous layer including heat-resistant fine particles as a main component. The method includes: preparing a resin porous film having a surface tension (wetting index) A of 35 mN/m or less, and coating the surface of the resin porous film with a heat-resistant porous layer forming composition containing a water-based solvent and having a surface tension B of less than 29 mN/m, and drying the applied composition to form a heat-resistant porous layer. The relationship between the surface tension (wetting index) A and the surface tension B satisfies A>B.

### EFFECTS OF THE INVENTION

According to the present invention, it is possible to provide a separator for an electrochemical device, which includes a highly heat-resistant layer and has good productivity an electrochemical device using the separator, and a method for producing the separator.

### BRIEF DESCRIPTION OF THE DRAWINGS

FIG. 1 is a diagram showing one example of a coater usable in the production of the separator for an electrochemical device of the present invention.

FIG. 2 is a schematic diagram for explaining a method of measuring the peel strength between the resin porous film and the heat-resistant porous layer of the separator for an electrochemical device at 180°.

### DESCRIPTION OF THE INVENTION

The separator for an electrochemical device (hereinafter simply referred to as the “separator”) of the present invention includes, on at least one side of a resin porous film including a thermoplastic resin as a main component, a heat-resistant porous layer.

The resin porous film of the separator of the present invention serves as the substrate of the separator, and plays, under normal circumstances in which an electrochemical device using the separator of the present invention is used, a role in separating the positive and negative electrodes.

On the other hand, the heat-resistant porous layer of the separator of the present invention is a layer for enhancing the heat resistance of the separator. For example, even if the internal temperature of an electrochemical device using the separator of the present invention becomes greater than or equal to the melting point of the thermoplastic resin forming the resin porous film, the heat-resistant porous layer prevents a short circuit resulting from direct contact between the positive and negative electrodes. Further, even if the resin porous film of the separator may thermally shrink, the heat-resistant porous layer suppresses thermal shrinkage of the separator as a whole. For these reasons, an electrochemical device using the separator of the present invention will be highly safe under high temperature conditions.

The separator of the present invention is produced through the steps of obtaining a heat-resistant porous layer forming composition (paint) by dispersing or dissolving constituent materials of the heat-resistant porous layer in a water-based solvent; coating the resin porous film as the substrate with the heat-resistant porous layer forming composition; and drying the applied composition to remove the solvent. And at the time of the production, the resin porous film having a surface tension (wetting index) A of 35 mN/m or less and the heat-resistant porous layer forming composition having a surface tension B, which is less than 29 mN/m and smaller than the surface tension (wetting index) A (i.e., the relationship between the surface tension (wetting index) A and the surface tension B satisfies A>B), are used. If the surface tension (wetting index) A of the resin porous film and the surface tension B of the heat-resistant porous layer forming composition are adjusted as above, the surface of the resin porous film can be coated favorably with the heat-resistant porous layer forming composition, so that the heat-resistant porous layer having good properties can be formed.

As will be described later, polyolefin is preferable as a thermoplastic resin to be the main component of the resin porous film. For example, polyethylene (PE) has a surface tension (wetting index) A of 31 mN/m, and polypropylene (PP) has a surface tension (wetting index) A of 29 mN/m. Therefore, the surface tension (wetting index) A of the resin porous film of the separator of the present invention can be adjusted by selecting a thermoplastic resin to be the main component of the resin porous film. For this reason, there is no need to subject the resin porous film to a hydrophilic treatment such as a corona discharge treatment, plasma treatment or the like to adjust its surface tension (wetting index). Consequently, it is possible to avoid heat damage to the resin porous film from such a hydrophilic treatment, and the development of defective parts during the production of the separator can be suppressed.

In the separator of the present invention, the productivity is improved by each of the above effects.

In the present invention, the surface tension (wetting index (mN/m)) A of the resin porous film (substrate) is measured in accordance with Japanese Industrial

Standards (JIS) K-6768.

The surface tension B of the heat-resistant porous layer forming composition can be measured by conventional methods, such as the plate method, the pendant drop method, and the maximum bubble pressure method.

The resin porous film of the separator of the present invention includes a thermoplastic resin as a main component. There is no particular limitation to the thermoplastic resin as long as any of the resins having a surface tension (wetting index) of 35 mN/m or less that are used broadly as separator materials in electrochemical devices using separators are used for the thermoplastic resin for forming the resin porous film. For example, polyolefin is preferable for electrochemical devices that have high potential and use a nonaqueous electrolyte, such as lithium-ion batteries and lithium polymer batteries, in terms of its stability in the devices. A lower limit to the surface tension (wetting index) of polyolefin is about 29 mN/m.

Examples of polyolefins suitable for the resin porous film include polyethylene (PE), polypropylene (PP), and ethylene-propylene copolymers.

The resin porous film of the separator of the present invention includes a thermoplastic resin as a main component. Thus, when an electrochemical device is exposed to elevated temperatures, the separator of the present invention can cause a so-called shutdown where the thermoplastic resin softens and blocks the pores of the separator. The temperature at which the separator causes a shutdown needs to be higher than a temperature range in which use of electrochemical devices is normally assumed and needs to be lower than temperatures considered as abnormal for electrochemical devices, for example, lower than the abnormal heat generation temperature of lithium-ion batteries. Thus, if the electrochemical device is a lithium-ion battery, the temperature at which a shutdown occurs due to the resin porous film of the separator is preferably 100 to 140° C.

For these reasons, the thermoplastic resin to be the main component of the resin porous film of the separator is preferably polyolefin whose melting point, i.e., whose melting temperature measured in accordance with JIS K 7121 with a differential scanning calorimeter (DSC) is 100 to 140° C., and more preferably PE.

For the resin porous film, it is possible to use any of conventionally known multilayer films made of the thermoplastic resins described above and used as separators in electrochemical devices (e.g., lithium-ion batteries), i.e., ion-permeable porous films (so-called microporous films) produced by processes such as solvent extraction, and dry or wet drawing (uniaxial or biaxial drawing).

Further, by using a thermoplastic resin having a surface tension (wetting index) of 35 mN/m or less to form the resin porous film as described above, the surface tension (wetting index) A of the resin porous film can be adjusted to 35 mN/m or less.

Here, the resin porous film including “a thermal plastic resin as a main component” means that the thermoplastic resin as the main component makes up 80 mass % or more of the constituent components of the resin porous film. The resin porous film may include only a thermoplastic resin. That is, the percentage of the thermoplastic resin in the resin porous film may be 100 mass %.

In terms of allowing favorable movements of ions in an electrochemical device, the pore size of the resin porous film is preferably 0.001 μm or more, and more preferably 0.01 μm or more. If the pore size of the resin porous film is too large, the ion permeability improves but the ratio of the pore size to the thickness of the separator becomes excessive and the ratio of the pore size to the particle size of active materials used in electrodes of an electrochemical device becomes excessive, which may reduce the effect of preventing a short circuit by separating the positive and negative electrodes. Therefore, the pore size of the resin porous film is preferably 10 μm or less, and more preferably 5 μm or less.

The pores of the resin porous film need to be “continuous pores” that are continuous from one side to the other of the resin porous film. As the form of the pores, the pores are preferably curved in the resin porous film rather than being so-called “straight pores” continuous from one side to the other of the resin porous film linearly. As a result of the pores of the resin porous film being curved, the potential for the occurrence of an internal short circuit in a lithium-ion battery due to the formation of lithium dendrites can be reduced, for example.

The heat-resistant porous layer of the separator of the present invention is a layer including heat-resistant fine particles as a main component. The term “heat-resistant” as used herein in connection with the heat-resistant fine particles means that changes in the shape, such as deformation, cannot be visually identified at least at 150° C. That is, the term “heat-resistant” refers to having a heat-resistant temperature of 150° C. or higher at which changes in the shape, such as deformation, do not occur. The heat-resistant temperature of the heat-resistant fine particles is preferably 200° C. or higher, more preferably 300° C. or higher, and even more preferably 500° C. or higher.

The heat-resistant fine particles are preferably inorganic fine particles having electrical insulation. Specific examples of such inorganic fine particles include: fine particles of inorganic oxides such as iron oxide, silica (SiO₂), alumina (Al₂O₃), TiO₂, BaTiO₃, and MgO; fine particles of inorganic nitrides such as aluminum nitride and silicon nitride; fine particles of hardly-soluble ionic crystals such as calcium fluoride, barium fluoride, and barium sulfate; fine particles of covalent crystals such as silicon and diamond; and fine particles of clays such as montmorillonite. The inorganic oxide fine particles may be fine particles of materials derived from mineral resources such as boehmite, zeolite, apatite, kaoline, mullite, spinel, olivine, and mica or artificial products of these materials. Moreover, the inorganic fine particles may be electrically insulating particles obtained by covering the surface of a conductive material with a material having electrical insulation such as any of the inorganic oxides mentioned above. Examples of the conductive material include: conductive oxides such as metals, SnO₂, and indium tin oxide (ITO); and carbonaceous materials such as carbon black and graphite.

Organic fine particles also can be used for the heat-resistant fine particles. Specific examples of organic fine particles include: fine particles of cross-linked polymers such as polyimide, melamine resins, phenol resins, cross-linked polymethyl methacrylate (cross-linked PMMA), cross-linked polystyrene (cross-linked PS), polydivinylbenzene (PDVB), and benzoguanamine-formaldehyde condensation products; and fine particles of heat-resistant polymers such as thermoplastic polyimide Each organic resin (polymer) forming these organic fine particles may be a mixture, a modified product, a derivative, a copolymer (a random copolymer, an alternating copolymer, a block copolymer, a graft copolymer), or a cross-linked product (in the case of the heat-resistant polymer) of the polymeric materials described above.

For the heat-resistant fine particles, the materials described above may be used alone or in combination of two or more. Among the heat-resistant fine particles mentioned above, inorganic oxide fine particles are more preferable, and alumina, silica, and boehmite are even more preferable.

The average particle size of the heat-resistant fine particles is preferably 0.001 μm or more, and more preferably 0.1 μm or more, and preferably 15 μm or less, and more preferably 1 μm or less. The average particle size of the heat-resistant fine particles can be defined as a number-average particle size measured with, for example, a laser diffraction particle size analyzer (e.g., “LA-920” manufactured by HORIBA, Ltd.) by dispersing the heat-resistant fine particles in a medium in which the heat-resistant fine particles do not dissolve.

The form of the heat-resistant fine particles may be close to spherical or may be plate-like. In terms of preventing a short circuit, the heat-resistant fine particles are preferably plate-like particles or particles having a secondary particle structure in which secondary particles are formed by agglomerated primary particles. Typical examples of plate-like particles and secondary particles include plate-like alumina, plate-like boehmite, alumina in the form of secondary particles, and boehmite in the form of secondary particles.

With regard to the form of plate-like particles, each plate-like particle has an aspect ratio (the ratio of the maximum length to the thickness of a plate-like particle) of preferably 5 or more, and more preferably 10 or more, and preferably 100 or less, and more preferably 50 or less. The aspect ratio of each plate-like particle can be determined by analyzing scanning electron microscope (SEM) images of the plate-like particles.

The heat-resistant porous layer includes the heat-resistant fine particles as a main component. The term “including as a main component” as used herein means that the heat-resistant fine particles included in the heat-resistant porous layer makes up 70 vol % or more of the total volume of the constituent components of the heat-resistant layer. The amount of the heat-resistant fine particles in the heat-resistant porous layer makes up more preferably 80 vol % or more, and even more preferably 90 vol % or more of the total volume of the constituent components of the heat-resistant porous layer. By increasing the amount of the heat-resistant fine particles included in the heat-resistant porous layer as above, thermal shrinkage of the separator as whole can be suppressed favorably. Further, it is preferable to include an organic binder in the heat-resistant porous layer for binding the heat-resistant fine particles together and for binding the heat-resistant porous layer and the resin porous film. From such a viewpoint, a preferred upper limit to the content of the heat-resistant fine particle in the heat-resistant porous layer is 99 vol % with respect to the total volume of the constituent components of the heat-resistant porous layer. If the amount of the heat-resistant fine particles in the heat-resistant porous layer is less than 70 vol %, the amount of organic binder in the heat-resistant porous layer needs to be increased, for example. In this case, the pores of the heat-resistant porous layer will be filled with the organic binder, which may lead to loss of the separator function, for example. If more pores are formed by using a pore forming agent or the like, the spacing between the heat-resistant fine particles will become too large, and the effect of suppressing thermal shrinkage may decrease.

Any organic binder can be used in the heat-resistant porous layer as long as it is capable of binding the heat-resistant fine particles together and binding the heat-resistant porous layer and the resin porous film favorably and is stable electrochemically and against a nonaqueous electrolyte included in an electrochemical device. Specific examples of organic binders include: ethylene-vinyl acetate copolymers (EVA; those having 20 to 35 mol % of a structural unit derived from vinyl acetate); ethylene-acrylic acid copolymers such as ethylene-ethyl acrylate copolymers; fluoro resins [such as polyvinylidene fluoride (PVDF)]; fluororubber, styrene-butadiene rubber (SBR); carboxymethyl cellulose (CMC); hydroxyethyl cellulose (HEC); polyvinyl alcohol (PVA); polyvinyl butyral (PVB); polyvinyl pyrrolidone (PVP); poly N-vinylacetamide; cross-linked acrylic resins; polyurethane; nylon; polyester; polyvinylacetal; and epoxy resins. These organic binders may be used alone or in combination of two or more.

Among the organic binders mentioned above, heat-resistant resins having a heat-resistant temperature of 150° C. or higher are preferable. In particular, highly flexible materials such as ethylene-acrylic acid copolymers, fluororubber and SBR are more preferable. Specific examples of these materials include: EVA such as “EVAFLEX series (trade name)” manufactured by DU PONT-MITSUI POLYCHEMICALS CO., LTD. and EVA manufactured by NIPPON UNICAR CO., LTD.; ethylene-ethyl acrylate copolymers (EEA) such as “EVAFLEX-EEA series (trade name)” manufactured by DU PONT-MITSUI POLYCHEMICALS CO., LTD. and EEA manufactured by NIPPON UNICAR CO., LTD.; fluororubber such as “DAI-EL LATEX series (trade name)” manufactured by DAIKIN INDUSTRIES, Ltd.; SBR such as “TRD-2001 (trade name)” manufactured by JSR Corporation and “BM-400B (trade name)” manufactured by LEON CORPORATION. Further, cross-linked acrylic resins having a low glass transition temperature and including butyl acrylate as a main component being cross-linked (self-cross-linked acrylic resins) are also preferable.

As described above, the heat-resistant porous layer of the separator is formed through the steps of coating the surface of the resin porous film with the heat-resistant porous layer forming composition, and drying the applied composition.

The heat-resistant porous layer forming composition contains the constituent materials of the heat-resistant porous layer, such as the heat-resistant fine particles and the organic binder as described above, and is obtained by dispersing or dissolving these constituent materials in a solvent.

A water-based solvent, i.e., a solvent predominantly composed of water is used for the heat-resistant porous layer forming composition. A water-based solvent may be composed only of water, but may also include a water-soluble organic solvent, for example, alcohol whose carbon number is 6 or less such as ethanol and isopropanol. The term “predominantly composed of water” means that water contained in the solvent makes up 50 mass % or more of the total weight of the solvent.

As described above, the surface tension B of the heat-resistant porous layer forming composition is set to be less than 29 mN/m and be smaller than the surface tension (wetting index) A of the resin porous film. To adjust the surface tension B of the heat-resistant porous layer forming composition as above, it is preferable to include a surfactant in the heat-resistant porous layer forming composition.

Examples of surfactants include hydrocarbon surfactants, fluorochemical surfactants, and silicone surfactants. Examples of hydrocarbon surfactants include: anionic surfactants such as fatty acid salt, cholate, sodium linear alkylbenzene sulfonate, and sodium lauryl sulfate; cationic surfactants such as tetraalkylammonium salt; ampholytic surfactants having both anionic and cationic sites in a molecule, and nonionic surfactants such as alkylglucoside. Examples of fluorochemical surfactants include those having a linear alkyl group, perfluoroalkenyl group, or the like as a hydrophilic group (e.g, perfluorooctanesulfonic acid and perfluorocarboxylic acid). Examples of silicone surfactants include polydimethylsiloxane, polyether-modified polydimethylsiloxane, and polymethylalkylsiloxane. These surfactants may be used alone or in combination of two or more.

As long as the surface tension B of the heat-resistant porous layer forming composition can be adjusted to the above-described value, the amount of surfactant in the heat-resistant porous layer forming composition is not limited. Specifically, the amount of surfactant is preferably 0.01 parts by mass or more, more preferably 0.02 parts by mass or more, and even more preferably 0.05 parts by mass or more with respect to 100 parts by mass of the solvent.

However, if the amount of surfactant in the heat-resistant porous layer forming composition is large, the adherence between the resin porous film and the heat-resistant porous layer declines, which makes it difficult to achieve preferred peel strength at 180°. If the adherence between the resin porous film and the heat-resistant porous layer of the separator declines, the effect of suppressing thermal shrinkage of the resin porous film as the substrate may decline. Further, if a large amount of surfactant is contained in the heat-resistant porous layer forming composition, the heat-resistant porous layer forming composition or its solvent is likely to pass through the resin porous film all the way to the opposite side via the pores (i.e., strike-through). This may deteriorate handling such as wetting a backup roll of a coater for applying the composition, or make it difficult to apply the composition in a desired application thickness.

For these reasons, the amount of surfactant in the heat-resistant porous layer forming composition is preferably 2 parts by mass or less, more preferably 1 part by mass or less, and even more preferably 0.5 parts by mass or less with respect to 100 parts by mass of the solvent.

Further, in terms of preventing the heat-resistant porous layer forming composition from striking through when coating the resin porous film with the heat-resistant porous layer forming composition, the surface tension B of the heat-resistant porous layer forming composition is preferably set to 15 mN/m or more.

By using the heat-resistant porous layer forming composition adjusted as above, it is possible to prevent the occurrence of strike-through during the production of the separator, and more specifically, it is possible to achieve a separator having no surfactant derived from the heat-resistant porous layer forming composition on the opposite side of the resin porous film to the side with the heat-resistant porous layer.

As a way to coat the resin porous film with the heat-resistant porous layer forming composition, a coater such as a gravure coater, a knife coater, a reverse roll coater, a die coater, etc., may be used.

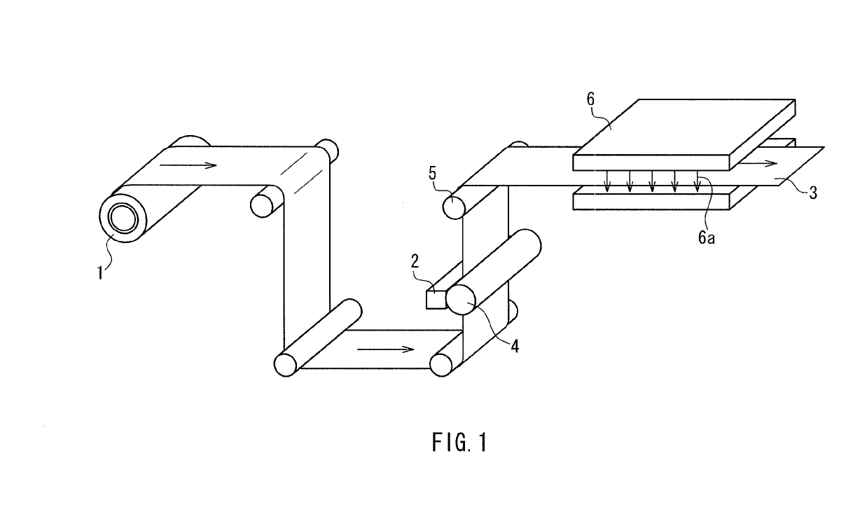

FIG. 1 is a diagram showing one example of a coater useable in the production of the separator of the present invention. When using the coater shown in FIG. 1 to produce the separator, first, a resin porous film 1 wound up in a roll state is drawn out, and a die head 2 applies the heat-resistant porous layer forming composition onto the surface of the resin porous film 1. At that time, making an adjustment to the amount of surfactant in the heat-resistant porous layer forming composition will lead to the prevention of contamination of the surface of a back roll 4 of the die head 2 and the surface of a turn roller 5 for transporting the coated resin porous film 1 resulting from the strike-through of the composition or its solvent, thereby allowing uniform application of the heat-resistant porous layer forming composition. Thereafter, the coating on the surface of the resin porous film 1 is dried in a drying zone 6, thus obtaining a separator (a multilayer porous film used as a separator) 3 including the resin porous film and the heat-resistant porous layer. In FIG. 1, the arrows 6a indicate the direction in which drying air is blown.

Although FIG. 1 shows an example of the production of the separator having the heat-resistant porous layer only on one side of the resin porous film 1, the separator of the present invention may be configured to have the heat-resistant porous layer only on one side of the resin porous film as above or may be configured to have the heat-resistant porous layers on both sides of the resin porous film. Further, the separator of the present invention may be configured to have not only more than one heat-resistant porous layer but also more than one resin porous film. However, an increase in the thickness of the separator due to an increase in the number of the layers may result in an increase in the internal resistance and a decline in the energy density of an electrochemical device. For this reason, an excessive increase in the number of the layers is not preferred. The number of the layers (the heat-resistant porous layer(s) and the resin porous film(s)) constituting the separator is preferably 5 or less, and more preferably 2 in total.

By making adjustments to the resin porous film and the heat-resistant porous layer forming composition such that the surface tension (wetting index) A and the surface tension B become the above-described values, and the surface tension (wetting index) A and the surface tension B satisfy the above-described relationship, the heat-resistant porous layer with good properties can be formed. Specifically, the heat-resistant porous layer can be formed in 95% or more of the surface area of the heat-resistant porous layer coated with the heat-resistant porous layer forming composition during the production of the separator. Further, it is possible to form the heat-resistant porous layer in which the number of pinholes with a diameter of 3 mm or more is 1 or less per 100 cm² of the heat-resistant porous layer formed.

Of the surface area of the resin porous film coated the heat-resistant porous layer forming composition, the percentage of the heat-resistant porous layer is determined as follows. A sample having a size of 10 cm×10 cm is cut from a part of the separator coated with the heat-resistant porous layer forming composition. Of this sample, an area that is coated favorably with the heat-resistant porous layer and has no coating dropout and no coating repelled portion is determined, and the area is divided by 100 cm² as the area of the sample (i.e., the area of the resin porous film) and expressed as a percent.

Further, the number of pinholes with a diameter of 3 mm or more in the heat-resistant porous layer per 100 cm² of the heat-resistant porous layer formed is determined by cutting a sample having a size of 10 cm×10 cm from a part of the separator coated with the heat-resistant porous layer, and counting the number of coating dropouts with a diameter of 3 mm or more in the sample.

In terms of suppressing a decline in the energy density of an electrochemical device and ensuring the function required of the separator (the function of separating the positive and negative electrodes favorably), the thickness (total thickness) of the separator of the present invention is preferably 6 to 50 μm.

Further, the ratio between Ta (μm) and Tb (μm) (Ta/Tb), where Ta is the thickness of the resin porous film of the separator and Tb is the thickness of the heat-resistant porous layer, is preferably 5 or less, more preferably 4 or less, and preferably 1 or more, and more preferably 2 or more. In this way, even if the percentage of the thickness of the resin porous film is increased and that of the heat-resistant porous layer is reduced in the separator of the present invention, thermal shrinkage of the separator as a whole can be suppressed, and the occurrence of a short circuit in an electrochemical device resulting from thermal shrinkage of the separator can be suppressed to a high degree. When the separator includes more than one resin porous film, the thickness Ta refers to the total thickness of the resin porous films, and when the separator includes more than one heat-resistant porous layer, the thickness Tb refers to the total thickness of the heat-resistant porous layers.

To express the thicknesses in specific values, the thickness of the resin porous film (the total thickness when there is more than one resin porous film) is preferably 5 μm or more, and preferably 30 μm or less. And the thickness of the heat-resistant porous layer (the total thickness when there is more than one heat-resistant porous layer) is preferably 1 μm or more, more preferably 2 μm or more, and even more preferably 4 μm or more, and preferably 20 μm or less, and more preferably 10 μm or less. If the thickness of the resin porous film is too small, a shutdown property to be imparted may especially weaken. In contrast, an excessively thick resin porous film may cause not only a decline in the energy density of an electrochemical device but also an increase in the thermal shrinkage force, so that the effect of suppressing thermal shrinkage of the separator as a whole may decline. Further, if the thickness of the heat-resistant porous layer is too small, the effect of suppressing thermal shrinkage of the separator as a whole may decline. In contrast, an excessively thick heat-resistant porous layer causes an increase in the thickness of the separator as a whole.

In terms of ensuring the retention of an electrolyte to improve the ion permeability, the porosity of the separator as a whole is preferably 30% or more in a dry state. On the other hand, in terms of ensuring the strength of the separator and preventing an internal short circuit, the porosity of the separator is preferably 70% or less in a dry state. The porosity P (%) of the multilayer porous film can be calculated from the thickness of the multilayer porous film, the mass per unit area of the multilayer porous film, and the densities of the constituent components of the multilayer porous film by obtaining a summation of each component i with the following formula (1).

P=100−(Σaᵢ/ρᵢ)×(m/t) (1)

Where aᵢ is the percentage of each component i by mass, ρᵢ is the density of each component i (g/cm³), m is the mass per unit area (g/cm²) of the separator, and t is the thickness (cm) of the separator.

Further, the porosity Pa (%) of the resin porous film can also be determined from the formula (1), where m is the mass per unit area (g/cm²) of the resin porous film, and t is the thickness (cm) of the resin porous film. The porosity of the resin porous film determined in this way is preferably 30 to 70%.

Further, the porosity Pb (%) of the heat-resistant porous layer can also be determined from the formula (1), where m is the mass per unit area (g/cm²) of the heat-resistant porous layer, and t is the thickness (cm) of the heat-resistant porous layer. The porosity of the heat-resistant porous layer determined in this way is preferably 20 to 60%.

In the separator of the present invention, the peel strength between the resin porous film and the heat-resistant porous layer at 180° is preferably 0.5 N/cm or more, and more preferably 1.0 N/cm or more. If the peel strength between the resin porous film and the heat-resistant porous layer satisfies these values, the effect of suppressing thermal shrinkage of the separator as a whole achieved by the action of the heat-resistant porous layer becomes more favorable, further improving the safety of an electrochemical device using the separator. An upper limit to the peel strength between the resin porous film and the heat-resistant porous layer at 180° is generally about 5 N/cm.

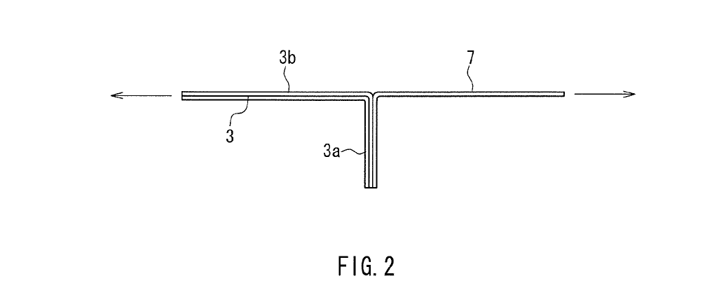

The peel strength between the resin porous film and the heat-resistant porous layer of the separator at 180° as described herein is determined by the following method. First, a test piece having a size of 5 cm in length and 2 cm in width is cut from the separator, and an adhesive tape is adhered to a 2 cm×2 cm area at one end of the heat-resistant porous layer of the test piece. The size of the adhesive tape is about 2 cm in width and 5 cm in length, and the adhesive tape is adhered to the test piece such that one end of the adhesive tape and one end of the separator align. Subsequently, of the separator test piece with the adhesive tape being adhered, the other end of the separator (the side opposite to the end with the adhesive tape) and the other end of the adhesive tape (the side opposite to the end adhered to the separator) are held by a tensile tester and are pulled at a tensile rate of 10 mm/min, and the strength at which the heat-resistant porous layer comes off is measured. FIG. 2 is a schematic side view of the separator test piece being pulled by the tensile tester (not shown). In FIG. 2, reference numeral 3 denotes the separator, reference numeral 3a denotes the resin porous film, reference numeral 3b denotes the heat-resistant porous layer, and reference numeral 7 denotes the adhesive tape, and the arrows in FIG. 2 are the tensile directions.

To achieve the above-described peel strength between the resin porous film and the heat-resistant porous layer of the separator at 180°, the resin porous film and the heat-resistant porous layer forming composition are adjusted such that the surface tension (wetting index) A and the surface tension B become the above-described values and the surface tension (wetting index) A and the surface tension B satisfy the above-described relationship, and the content of surfactant in the heat-resistant porous layer forming composition is set to the above-described value.

Next, the electrochemical device of the present invention will be described. As long as the electrochemical device of the present invention uses the separator of the present invention, its other components and structure are not particularly limited. Thus, it can be configured in the form of various conventionally-known electrochemical devices including a nonaqueous electrolyte, such as a lithium-ion battery (primary or secondary battery), a polymer-lithium battery, and an electric double-layer capacitor. In particular, the electrochemical device of the present invention can be suitably used in applications requiring safety at elevated temperatures.

As one example of the electrochemical device of the present invention, hereinafter, the application to a lithium-ion secondary battery will be described in detail. The lithium-ion secondary battery may be in the form of a cylindrical (e.g., rectangular cylindrical or circular cylindrical) battery using a steel can, an aluminum can or the like as an outer case can, or a soft package battery using a laminated film having a metal vapor-deposited thereon as an outer case member.

There is no particular limitation to the positive electrode as long as one used in conventional nonaqueous electrolyte batteries is used. The positive electrode can be produced by adding a conductive assistant (e.g., a carbon material such as carbon black), a binder such as PVDF and the like to a positive electrode active material as appropriate to obtain a positive electrode mixture, and applying the positive electrode mixture to both sides of a positive electrode current collector to form positive electrode mixture layers.

For the positive electrode active material, it is possible to use, for example, any of the following: lithium-containing transition metal oxides represented by Li₁₊ₓMO₂ (where −0.1<x<0.1, and M is Co, Ni, Mn, etc.); spinel lithium-manganese composite oxides represented by LiMₓMn₂₋ₓO₄ (where M is at least one selected from Li, B, Mg, Ca, Sr, Ba, Ti, V, Cr, Fe, Co, Ni, Cu, Al, Sn, Sb, In, Nb, Mo, W, Y, Ru and Rh, and 0.01≦x≦0.5); olivine LiMPO₄ (where M is Co, Ni, Mn or Fe); LiMn_{0.5}Ni_{0.5}O₂; and Li₍₁₊ₐ₎MnₓNi_{y}Co_{(1-x-y)}O₂ (where −0.1<a<0.1, 0<x<0.5, and 0<y<0.5).

For the positive electrode current collector, a foil, a punched metal, a mesh, or an expanded metal made of aluminum or the like may be used, for example. Normally, an aluminum foil with a thickness of 10 to 30 μm is suitably used.

Generally, a positive electrode lead portion is provided in the following manner. At the time of the production of the positive electrode, the positive electrode mixture layer is not formed on a part of the positive electrode current collector to leave it exposed, and this exposed portion serves as the lead portion. It is to be noted that there is no need for the positive electrode lead portion to be integral with the positive electrode current collector from the beginning, and may be provided by connecting an aluminum foil or the like to the positive electrode current collector afterwards.

There is no particular limitation to the negative electrode as long as one used in conventional nonaqueous electrolyte batteries is used. The negative electrode can be produced by adding a conductive assistant (e.g., a carbon material such as carbon black), a binder such as PVDF and the like to a negative electrode active material as appropriate to obtain a negative electrode mixture, and applying the negative electrode mixture to both sides of a negative electrode current collector to form negative electrode mixture layers.

For the negative electrode active material, it is possible to use, for example, any of the following: carbon materials capable of intercalating and deintercalating lithium such as graphite, pyrolytic carbons, cokes, glassy carbons, calcined organic polymer compounds, mesocarbon microbeads (MCMB), and carbon fibers: and compounds that can be charged/discharged at a low voltage close to lithium metal such as lithium-containing nitrides and lithium-containing oxides. The carbon materials can be used alone or in combination of two or more.

Further, it is also possible to use elements such as Si, Sn, Ge, Bi, Sb and In and alloys thereof or lithium metals and lithium/aluminum alloy for the negative electrode active material. When using any of these various alloys and metals such as lithium metals for the negative electrode active material, a foil made of such metal may be used alone to form the negative electrode. Or, the metal may be placed on a negative electrode current collector to form the negative electrode.

When using a negative electrode current collector, a foil, a punched metal, a mesh, an expanded metal or the like made of copper, nickel, or the like is used for the negative electrode current collector. Normally, a copper foil is used. When reducing the thickness of the negative electrode as a whole to achieve a battery with a high energy density, an upper limit to the thickness of the negative electrode current collector is preferably 30 μm, and a lower limit to the thickness is desirably 5 μm.

As with the positive electrode lead portion, a negative electrode lead portion is generally provided in the following manner. At the time of production of the negative electrode, the negative electrode mixture layer is not formed on a part of the negative electrode current collector to leave it exposed, and this exposed portion serves as the lead portion. It is to be noted that there is no need for the negative electrode lead portion to be integral with the negative electrode current collector from the beginning, and may be provided by connecting a copper foil or the like to the negative electrode current collector afterwards.

The positive electrode and the negative electrode described above may be laminated through the separator of the present invention and used in the form of a laminated electrode body or a wound electrode body which is the laminated electrode body being further wounded.

For the nonaqueous electrolyte of the lithium-ion secondary battery, one prepared by dissolving lithium salt in an organic solvent is used. Examples of the organic solvent include dimethyl carbonate, diethyl carbonate, methyl ethyl carbonate, methyl propionate, ethylene carbonate, propylene carbonate, butylene carbonate, γ-butyrolactone, ethylene glycol sulfite, 1,2-dimethoxyethane, 1,3-dioxolane, tetrahydrofuran, 2-methyl-tetrahydrofuran and diethylether, and these organic solvents can be used alone or in combination of two or more. The lithium salt is at least one selected from LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃, (2≦n≦7), and LiN(RfOSO₂)₂ (where Rf is a fluoroalkyl group). The concentration of the lithium salt in the nonaqueous electrolyte is preferably 0.5 to 1.5 mol/L, and more preferably 0.9 to 1.25 mol/L.

Further, ambient temperature molten salts such as ethyl-methylimidazolium trifluoromethylsulfonium imide, heptyl-trimethylammonium trifluoromethylsulfonium imide, pyridinium trifluoromethylsulfonium imide, and guazinium trifluoromethylsulfonium imide also can be used in place of the organic solvent.

Moreover, host polymers capable of forming a gel electrolyte, such as PVDF, vinylidene fluoride-hexafluoropropylene copolymers (PVDF-HFP), polyacrylonitrile (PAN), polyethylene oxide, polypropylene oxide, ethylene oxide-propylene oxide copolymers, cross-linked polymers having an ethylene oxide chain as their main chain or side chain, and cross-linked poly(meth)acrylic ester, may be used to use the nonaqueous electrolyte in the gelated form.

The electrochemical device of the present invention can be used in a variety of applications in which conventionally-known electrochemical devices including a nonaqueous electrolyte are used.

### EXAMPLES

Hereinafter, the present invention will be described in detail by way of Examples. It is to be noted that the present invention is not limited to the following Examples.

Each measurement in the following Examples and Comparative Examples was carried out as follows. An automatic surface tension meter (“CBVP-Z” manufactured by Kyowa Interface Science Co., Ltd) was used to measure the surface tension B of each heat-resistant porous layer forming slurry (heat-resistant porous layer forming composition). The surface tension A (wetting index (mN/m)) of each resin porous film was measured in accordance with JIS K-6768. The peel strength between the resin porous film and the heat-resistant porous layer at 180° was measured by the above-described method with the adhesive tape being a double-faced tape (“No. 5011N manufactured by Nitto Denko Corporation).

Further, the thermal shrinkage rate of each separator was measured by the following method. First, a strip-shaped sample piece 5 cm in a MD direction and 10 cm in a TD direction is cut from the separator. Here, the MD direction refers to the machine direction during the production of the resin porous film, and the TD direction refers to a direction perpendicular to the MD direction. With an oil magic marker, 3 cm lines were marked on the sample parallel to the MD direction and to the TD direction such that the lines intersected at the center in. the MD direction and that in the TD direction. The intersection of these lines was set as the center of each line. This sample was hung in a thermostat, and the temperature in the thermostat was raised at a rate of 5° C./min. After the temperature reached 150° C., the temperature was maintained at 150° C. for one hour, and the lengths of the marked lines in the MD direction and the TD direction after one hour at 150° C. were measured. And from the lengths of the marked lines before and after the heating, the thermal shrinkage rate in each of the MD direction and the TD direction was measured.

### Example 1

300 g of emulsion of SBR as an organic binder (solid content: 40 mass %) and 4000 g of water were put in a container, and they were stirred at ambient temperature until the emulsion was dispersed uniformly in the water. To this dispersion, boehmite powder (plate-like in shape, average particle size: 1 μm, aspect ratio: 10) as heat-resistant fine particles having a heat-resistant temperature of 150° C. or higher was added four times in total of 4000 g. Further, a carboxymethyl cellulose aqueous solution (solid content: 1 part by mass with respect to 100 parts by mass of the heat-resistant fine particles) as a thickener was added to the dispersion, and they were stirred with a disperser at 2800 rpm for 5 hours, thus preparing an uniform slurry. Perfluorooctanesulfonic acid as a fluorochemical surfactant was added to this slurry at a ratio of 0.1 parts by mass perfluorooctanesulfonic acid to 100 parts by mass water, thus obtaining a heat-resistant porous layer forming slurry: APE porous film (thickness: 12 μm) as a resin porous film was coated with the heat-resistant porous layer forming slurry using a gravure coater, followed by drying of the applied slurry, thus obtaining a separator having a double layer structure of the resin porous film and the heat-resistant porous layer and a thickness of 16 μm. Here, the surface tension (wetting index) A of the PE porous film used as the resin porous film was 30 mN/m and the surface tension B of the heat-resistant porous layer forming slurry was 21.5 mN/m.

### Example 2

A heat-resistant porous layer forming slurry was prepared in the same manner as in Example 1 except that a dimethylpolysiloxane polyoxyalkylene copolymer as a silicone surfactant was used as a surfactant. Except using this slurry, a separator was produced in the same manner as in Example 1.

### Example 3

A heat-resistant porous layer forming slurry was prepared in the same manner as in Example 1 except that the surfactant was added at a rate of 2.5 parts by mass surfactant to 100 parts by mass water. Except using this slurry, a separator was produced in the same manner as in Example 1.

### Comparative Example 1

A heat-resistant porous layer forming slurry was prepared in the same manner as in Example 1 except that no surfactant was used. Except using this slurry, a separator was produced in the same manner as in Example 1.

### Comparative Example 2

A heat-resistant porous layer forming slurry was prepared in the same manner as in Example 1 except the surfactant was added at a rate of 0.005 parts by mass surfactant to 100 parts by mass water. Except using this slurry, a separator was produced in the same manner as in Example 1.

For each of the separators of Examples 1 to 3 and Comparative Examples 1 to 2, the surface tension (wetting index) A of the resin porous film and the surface tension B of the heat-resistant porous layer forming composition used in the production, the peel strength between the resin porous film and the heat-resistant porous layer at 180°, and the thermal shrinkage rate are shown in Table 1. Between the thermal shrinkage rate in the MD direction and that in the TD direction, whichever is greater is shown as the thermal shrinkage rate of the separator. The percentage of the heat-resistant porous layer formed in the surface area of the resin porous film coated with the heat-resistant porous layer forming composition (labeled as “Coating rate” in Table 1), and the number of pinholes with a diameter of 3 mm or more in the heat-resistant porous layer per 100 cm² of the heat-resistant porous layer formed (labeled as “Number of pinholes” in Table 1) are also shown in Table 1.

TABLE 1

| | Surface tension | | | Thermal | | |
|---|---|---|---|---|---|---|
| | (wetting index) | Surface | Peel | shrinkage | Heat-resistant porous layer | |
| | A | tension B | strength | rate | Coating rate | Number of |
| | (mN/m) | (mN/m) | (N/cm) | (%) | (%) | pinholes |
| Ex. 1 | 30 | 21.5 | 1.4 | 3 | 100 | 0 |
| Ex. 2 | 30 | 27.3 | 1.5 | 3 | 100 | 0 |
| Ex. 3 | 30 | 20.2 | 0.4 | 28 | 100 | 0 |
| Comp. Ex. 1 | 30 | 37.6 | — | 40 | 10 | — |
| Comp. Ex. 2 | 30 | 32.1 | 0.8 | 22 | 80 | 10 |

As shown in Table 1, in the separators of Examples 1 to 3 each formed by using the resin porous film and the heat-resistant porous layer forming slurry whose surface tensions (the surface tension (wetting index) A and the surface tension B) were adequate and had an adequate relationship, the heat-resistant porous layer was formed favorably as the heat-resistant porous layer coating rate was high and no pinhole was found.

In contrast, in the separators of Comparative Examples 1 to 2 each formed by using the heat-resistant porous layer forming slurry with an inadequate surface tension B, since the heat-resistant porous layer forming slurry was repelled at the time of coating the surface of the resin porous film and thus could not be applied uniformly, the heat-resistant porous layer with good properties could not be formed. Especially, in the separator of Comparative Example 1 formed by using the heat-resistant porous layer forming slurry containing no surfactant, the heat-resistant porous layer was hardly formed, so that the peel strength and the number of pinholes could not be measured.

Further, the separators of Examples 1 to 2 had larger peel strength than that of the separator of Example 3. Presumably, the reason for this is that the amount of surfactant added to the heat-resistant porous layer forming slurry used for each of the separators of Examples 1 and 2 was smaller than that in Example 3. Further, the the separators of Examples 1 to 2 had a smaller thermal shrinkage rate than that of the separator of Example 3. Presumably, the reason for this is that the peel strength between the resin porous film and the heat-resistant porous layer was large and thus the adhesion between the both layers was high in the separators of Examples 1 to 2, so that shrinkage of the resin porous film was suppressed favorably by the heat-resistant porous layer.

### Example 4

### <Production of Positive Electrode>

90 parts by mass of LiCoO₂ as a positive electrode active material, 7 parts by mass of acetylene black as a conductive assistant, and 3 parts by mass of PVDF as a binder were mixed uniformly in N-methyl-2-pyrrolidone (NMP) as a solvent, thus preparing a positive electrode mixture containing paste. This paste was applied intermittently onto both sides of a 15 um-thick aluminum foil as a current collector such that the application length was 280 mm on the front side and 210 mm on the backside, which then was dried and calendered to adjust the total thickness of the positive electrode mixture layers to 150 Subsequently, this current collector was cut such that it would be 43 mm in width, thus producing a positive electrode. Further, a positive electrode lead portion was welded to an exposed portion of the aluminum foil of the positive electrode.

### <Production of Negative Electrode>

95 parts by mass of graphite as a negative electrode active material and 5 parts by mass of PVDF as a binder were mixed uniformly in NMP as a solvent, thus preparing a negative electrode mixture containing paste. This paste was applied intermittently onto both sides of a 10 μm-thick copper foil as a current collector such that the application length was 290 mm on the front side and 230 mm on the backside, which then was dried and calendered to adjust the total thickness of the negative electrode mixture layers to 142 μm. Subsequently, this current collector was cut such that it would be 45 mm in width, thus producing a negative electrode. Further, a negative electrode lead portion was welded to an exposed portion of the copper foil of the negative electrode.

### <Assembly of Battery>

The positive electrode and the negative electrode obtained as above were laminated through the separator of Example 1 such that the heat-resistant porous layer opposed the negative electrode, and they were wound in a spiral fashion to produce a wound electrode body. The wound electrode body obtained was pressed into a flat shape, and then was placed in an outer package made of a laminate film. A nonaqueous electrolyte (a solution obtained by dissolving LiPF₆ at a concentration of 1.2 mol/L in a mixed solvent of ethylene carbonate and ethylmethyl carbonate at a volume ratio of 1 to 2) was injected into the outer package, and the opening of the outer package was sealed, thus producing a battery

### Example 5

A battery was produced in the same manner as in Example 4 except that the separator of Example 2 was used.

### Example 6

A battery was produced in the same manner as in Example 4 except that the separator of Example 3 was used.

### Comparative Example 3

A battery was produced in the same manner as in Example 4 except that the separator of Comparative Example 2 was used.

The charge/discharge characteristics of the batteries of Examples 4 to 6 and Comparative Example 3 were evaluated as follows. First, as initial charging, each battery was charged at a constant current of 150 mA at 25° C. until the battery voltage reached 4.2 V, and subsequently was charged at a constant voltage of 4.2 V. The total charging time was 12 hours. Next, each charged battery was discharged at a constant current of 150 mA. Thereafter, each battery was charged at a constant current of 500 mA at −5° C. until the battery voltage reached 4.2 V, and subsequently was charged at a constant voltage of 4.2 V. The total charging time was 2.5 hours.

Each charged battery was dissembled to observe the surface of the negative electrode to determine the charged state. Gray portions resulting from the precipitation of lithium metal were hardly seen in the batteries of Examples 4 to 6 and the batteries were charged uniformly. In contrast, in the battery of Example 3, many gray portions were seen and it was found that the charged state was not uniform due to the unevenness of the heat-resistant porous layer of the separator.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### DESCRIPTION OF REFERENCE NUMERALS

1 resin porous film
2 die head
3 separator
3a resin porous film
3b heat-resistant porous layer
4 back roll
5 turn roll
6 drying zone
7 adhesive tape

1. A separator for an electrochemical device, comprising, on at least one side of a resin porous film comprising a thermoplastic resin as a main component, a heat-resistant porous layer comprising heat-resistant fine particles as a main component,
wherein the resin porous film has a surface tension (wetting index) A of 35 mN/m or less,
the heat-resistant porous layer is made from a heat-resistant porous layer forming composition containing a water-based solvent and having a surface tension B of less than 29 mN/m, and
a relationship between the surface tension (wetting index) A and the surface tension B satisfies A>B.

2. The separator according to claim 1, wherein peel strength between the resin porous film and the heat-resistant porous layer at 180° is 0.5 N/cm or more.

3. The separator according to claim 1, wherein the heat-resistant porous layer forming composition contains 0.01 to 2 parts by mass of a surfactant with respect to 100 parts by mass of the solvent.

4. The separator according to claim 3, wherein the surfactant is at least one selected from the group consisting of a hydrocarbon surfactant, a fluorochemical surfactant, and a silicone surfactant.

5. The separator according to claim 3, wherein the surfactant is not present on an opposite side of the resin porous film to the side with the heat-resistant porous layer.

6. The separator according to claim 1, wherein the heat-resistant porous layer is formed in 95% or more of a surface area of the resin porous film coated with the heat-resistant porous layer forming composition.

7. The separator according to claim 1, wherein the number of pinholes with a diameter of 3 mm or more in the heat-resistant porous layer is 1 or less per 100 cm² of the heat-resistant porous layer formed.

8. An electrochemical device comprising a positive electrode, a negative electrode, a separator, and a nonaqueous electrolyte,
wherein the separator is the separator according to claim 1.

9. A method for producing a separator for an electrochemical device, the separator comprising, on at least one side of a resin porous film comprising a thermoplastic resin as a main component, a heat-resistant porous layer comprising heat-resistant fine particles as a main component, the method comprising:
preparing a resin porous film having a surface tension (wetting index) A of 35 mN/m or less, and
coating a surface of the resin porous film with a heat-resistant porous layer forming composition containing a water-based solvent and having a surface tension B of less than 29 mN/m, and drying the applied composition to form a heat-resistant porous layer,
wherein a relationship between the surface tension (wetting index) A and the surface tension B satisfies A>B.

10. The method according to claim 9, wherein the heat-resistant porous layer forming composition contains 0.01 to 2 parts by mass of a surfactant with respect to 100 parts by mass of the solvent.

11. The method according to claim 10, wherein the surfactant is at least one selected from the group consisting of a hydrocarbon surfactant, a fluorochemical surfactant, and a silicone surfactant.

12. The method according to claim 10, the surfactant is not present on the other side of the resin porous film.
